(19) United States
(12) Patent Application Publication
(10) Pub. No.: US 2010/0154046 A1
(43) Pub. Date: Jun. 17, 2010

(54) SINGLE SIGN-ON METHOD AND SYSTEM FOR WEB BROWSER

(75) Inventors: Te-Chen Liu, Taipei County (TW); Tsung-Jen Huang, Taichung City (TW); Ching-Yao Wang, Guiren Shiang (TW)

Correspondence Address: Allen, Dyer, Doppelt, Milbrath & Gilchrist, P.A., Suite 1401, 255 South Orange Avenue, Orlando, FL, 32801, US

(73) Assignee: Industrial Technology Research Institute, Hsinchu (TW)

(21) Appl. No.: 12/508,014

(22) Filed: Jul. 23, 2009

(30) Foreign Application Priority Data
Dec. 17, 2008 (TW) 097149297

(51) Int. Cl. G06F 21/20; G06F 15/16

(52) U.S. Cl. 726/8; 726/9

(57) ABSTRACT

A single sign-on methodology across web sites and web services is provided. The method is also a single sign-on (SSO) system, so the user's identification information interacts across the web sites and the back end web services. The user can enter each various web site after taking one entrance procedure, and access surely the back end service of web site by the identity oneself at various web site. The present disclosure can make the web service to identify directly and control the terminal user and achieve the control by the identity authority of the terminal user. This system can be deployed rapidly into a organized system under the prerequisite of reserving prior system as the one to deploy the system which has possessing the SSO system of the web site or web service, because the present disclosure takes the foundation of the prior SSO solution.

### TECHNICAL FIELD

The present disclosure relates to a web system, and more particularly to a single sign-on (SSO) method and system for a web browser.

### BACKGROUND

General speaking, the SSO domain signifies a group of service by a set SSO system to share the validation information. Conventionally, the web service only proceeds the validation to the web site as client end, rather than proceeds the validation to the user surfing the web site. In other words, the web site and the web service belong respectively to different SSO domains, the web service only identifies the service accessed by the client end of web site, rather than identifies who is the user of the client end of web site. Such condition would lead to the web service being unable to execute correct discrimination of limits of authority about further user. However, we can make the web service to intensify its safety validation if we can transmit the identity information to the web service of the back end from the user of the front end by the SSO service. The range of authority is set by oneself and the user's convenience is considered simultaneously.

Referring to FIG. 1, there is shown a Back End Service (BES) of the web and the web site use respectively different validation information, i.e. the SSO doesn't integrate the validation information of the web site and the web service. One user (e.g. Bob) 10 surfs webs by running a browser, as Bob logins at the web site A under the conventional SSO system. The system coerces toward the Identity Provider (IDP) of a web site after entrance, and asks the IDP to issue the SSO identifiable for web site to the user Therefore, the user can access the web site B by his own exclusive Security Token (ST) of the web sites (as in fig., an arrow 11 that points form the web site A toward the browser, and an arrow 12 that points from the browser toward the web site B). The user can access the two web sites: the web site A (as in fig., an arrow that points from the browser toward the web site A) and the web site B, and then obtains the responses from the two web sites (as in fig., an arrow that points from the web site A or the web site B). Namely, one IDP of web sites provides the SSO validation service of the basis by token for many web sites, wherein the web site B would use the back-end web service as the source of the information. One IDP of web services provides the SSO validation service of the basis by token for many web services. However, the web service only knows the accessing client end which is the web site B, i.e. merely knows that the Web Site B has Entered and cannot know that the user is actually Bob. Consequently, the back-end web service cannot judge the authority issue by the identity of user 10 at the browser end, merely judges the user who comes from the web site B.

Accordingly, the present disclosure aims to extend the SSO domain of the web sites to the back-end web services, so as to overcome that the web service cannot know the identity information of end user 10. No extra manipulating procedure is necessary at the same time. However, the web site system and the web service system are distinct respectively. There are many differences between the various constitution systems of the SSO procedures and the mode used to transmit information. Referring to FIG. 2, a person 20 having the general knowledge in the skill field belonged to the present disclosure can find that the web site SSO and the web service SSO contain many features:

1. Communication Protocol: the web site is the binding of the Post/Get of the Hypertext Transmission Protocol (HTTP), yet POAS is a method for the web service to apply the binding of the SSO (i.e. POAS is another name for the implementation of the Liberty Reverse HTTP Binding for SOAP Specification);

2. Secure Protocol: the web site uses the Secure Socket Layer (SSL), yet the Web Service (WS) uses the WS-Security;

3. Method to bind the SSO message: the web site bind the validation information by POST or GET into the FORM or the Uniform Resource Locator (URL), yet the web service must attach the validation information into the package of the Simple Object Access Protocol (SOAP).

Referring to FIG. 3, for example, the Organization for the Advancement of Structured Information Standards (OASIS) provides explicit practical methods in the standard of the Security Assertion Markup Language (SAML) 2.0 for the single sign-on of the web site and the web service. For the example of the SAML 2.0, as the User Agent (UA) wants to access the service, the identity information is first validated by the Identity Provider (IDP). The identity information is recorded at the Security Token (ST), the Service Provider (SP) only confides IDP. The process of validation includes the AuthnRequest, only the ST issued from IDP is right a legal source of identity information.

As regards how to apply ST for proceeding the SSO, there are different ways under different circumstances, e.g. the SAML 2.0 has defined several different profiles. Each profile describes the practicing methods of the SSO standard under different applied circumstances, wherein the web SSO profile and the Enhanced Client/Proxy SSO profile express respectively under the circumstances of the web site and the web service to apply SAML for the methods of practicing SSO. However, we can find that there are distinct variations in the two applied skills from the Table 1. These variations contain the differences of the applied communication protocol and the binding methods from ST to communication protocol.

TABLE 1
SAML Profiles

| | Suitable | | |
|---|---|---|---|
| SAML Profile | Circumstances | SAML Binding | Applied Technique |
| Web SSO | Cross Web | HTTP Redirect | HTTP POST/GET |
| | Site SSO | HTTP POST | HTTP Redirect |
| | | HTTP Artifact | Cookie |
| | | | SSL |
| Enhanced | Cross Web | PAOS | SOAP |
| Client/Proxy | Service or other | | WS-*/SSL |
| SSO | Service SSO | | |

The Cookie in the table overhead means the small-scale character file.

Referring to FIG. 4, which is a schematic diagram of the truss of one prior single sign-on, U.S. Pat. No. 7,249,375 B2 (called Case A hereafter), Method and Apparatus for End-to-End Identity Propagation, July 2007 are shown. Case A describes a single sign-on method which integrates the front end application program and the back end application program into one SSO domain. In the circumstance of Case A, all application programs (including the front end and the back end) confide wholly the same safety ST. Case A may share the identity information of a user 40 between the front end and the back end application programs. In addition, there is only one single sigh-on server 41.

Referring to FIG. 5, which is a schematic diagram of the truss of another prior single sign-on, US 2008/0,014,931 A1 (called Case B hereafter), Distribute Network Identity, January 2008 is shown. Case B describes a single sign-on method which includes a Service Provider A (SP A) 50. There are plural IDPs A, B 51, 52 in the SSO domain, and forms a trust chain between IDPs, so the services dispersed at each place can have respective IDP, but there is no solving plan of integration of the various constitution interface in Case B. In addition, the token of Case B would record this token ever validated by which IDPs. Each IDP forms a trust chain, and Case B cannot know whether the condition of the token obtained is indeed renovated by the web site IDP.

A single sign-on system of trans-various constitution schemes based on the prior SSO standard will be established according to the embodiments of the present disclosure, so the building man integrate the validation information of the users of the web site and the web service under the situation of no need to alter substantially existent SSO system. And it accomplishes the single sign-on across the web site and the web service.

### SUMMARY

According to an embodiment of the present disclosure, it's a single sign-on method for a web browser, which includes steps of validating an entrance data by a first web site, providing a web site security token to the web browser when the first web site validates the entrance data as correctness, accessing a second web site by the web site security token, generating a web service security token by the second web site, issuing the web service security token to the second web site when the web site security token is validated as correctness, and then providing the web service security token by the second web site, and accessing an application information by the second web site with the web service security token for transmission the application information to the first web site.

According to another embodiment of the present disclosure, it's a single sign-on method, which includes steps of receiving a web site security token, utilizing the web site security token to request a web service security token, issuing the web service security token when the web site security token is validated as correctness, and utilizing the web service security token to access an application information.

In addition, one embodiment of the present disclosure is a single sign-on system for a web browser, including a first web site validating an entrance data, a web site identity provider providing a web site security token to the web browser when the first web site validates the entrance date as correctness, a second web site accessed by the web site security token, a web service identity provider validating the web site security token at the web site identity provider and providing a web service security token, and validating the web site security token by the web site identity provider for a requesting instruction of the second web to decide whether the web service security token is issued to the second web site or not, and a web service center accessed by the web service security token, then providing an application information to the second web site for responding the application information to the first web site by the second web site.

Provided that it is viewed from another acceptable pattern, the present disclosure is a single sign-on system, comprising a first identity provider providing a web site security token, a second identity provider validating the web site security token at the first identity provider and providing a web service security token, when the web site security token is validated as correctness for a requesting instruction, then deciding whether the web service security token is issued or not, and a web service center accessed by the web service security token, then providing an application information.

The words that follow cite specially embodiments for easier apparent understanding the above-mentioned characters and virtues of the present invention, and are tied in with the figures attached for detailed statement as below.

### BRIEF DESCRIPTION OF THE DRAWINGS

FIG. 1 is a schematic diagram of the SSO having no integration of validation information of the web site and the web service according to the prior art;

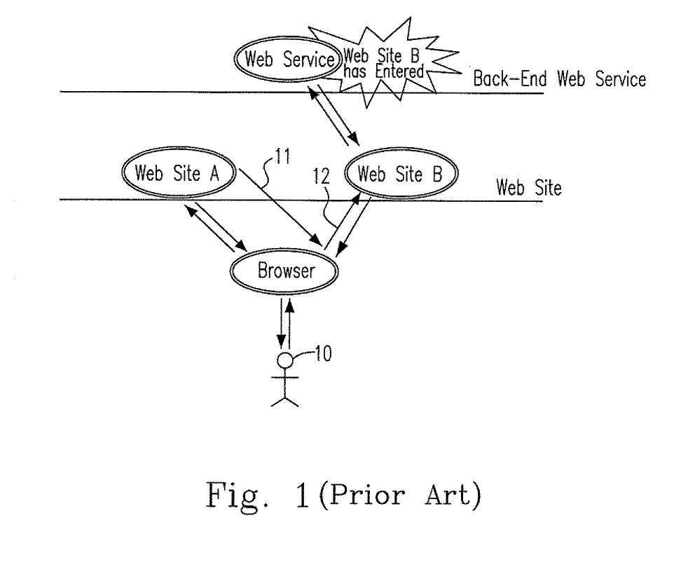

FIG. 2 is a schematic diagram of skill difference of the web site SSO and the web service SS according to the prior art;

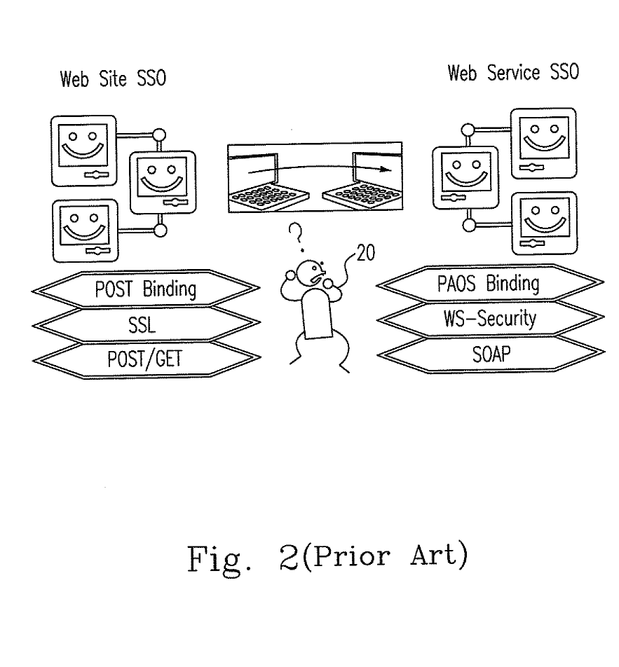

FIG. 3 is a schematic diagram of the basic mode of the single sign-on of the prior SAML 2.0 according to the prior art;

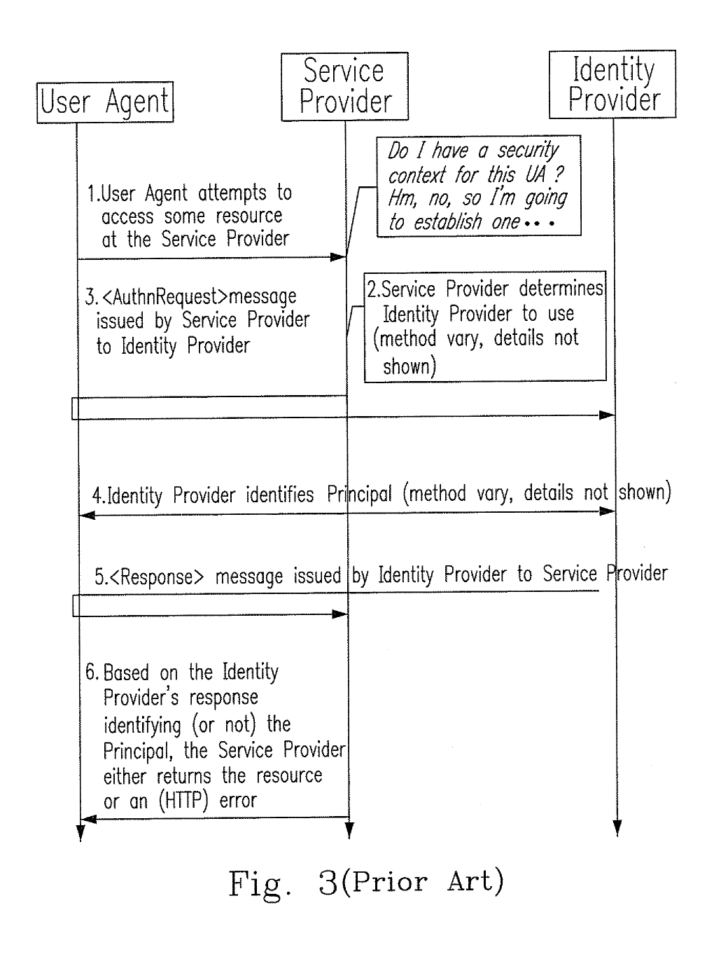

FIG. 4 is a schematic diagram of the truss of one prior single sign-on according to the prior art;

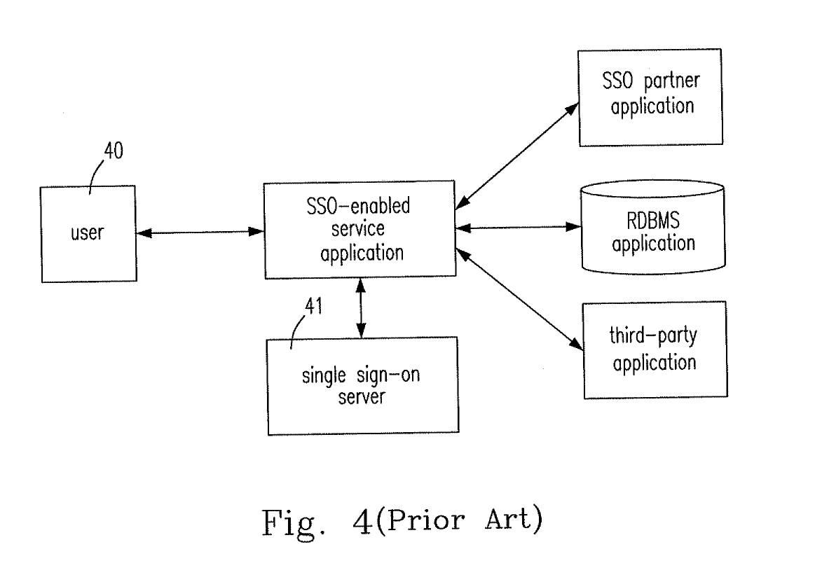

FIG. 5 is a schematic diagram of the truss of another prior single sign-on according to the prior art;

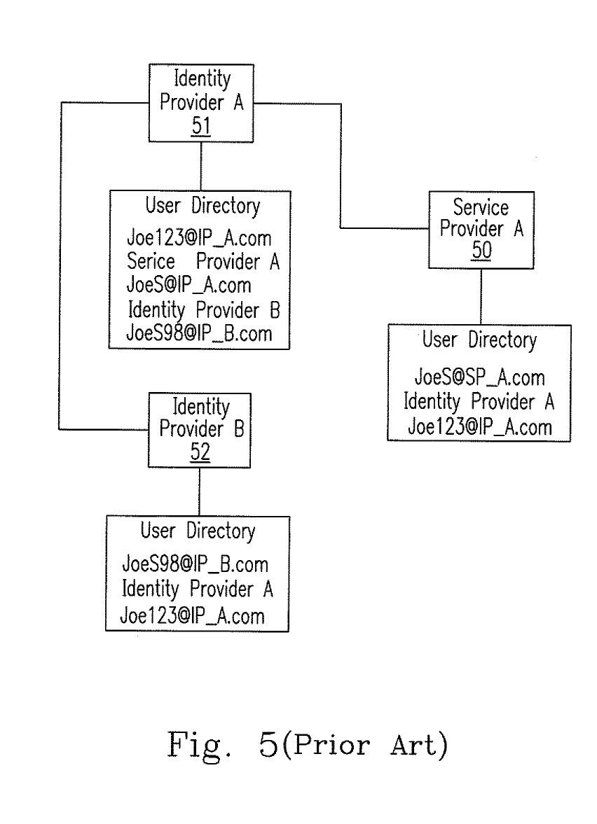

FIG. 6 is a schematic diagram of the concept embodiment of the operation procedure of a single sign-on method and system for a web browser according to the present disclosure;

FIG. 7 is a schematic diagram of an embodiment system in proper sequence according to the present disclosure; and

FIG. 8 is a schematic diagram of an embodiment of a single sign-on method and system for a web browser according to the present disclosure.

### DETAILED DESCRIPTION OF THE EMBODIMENT

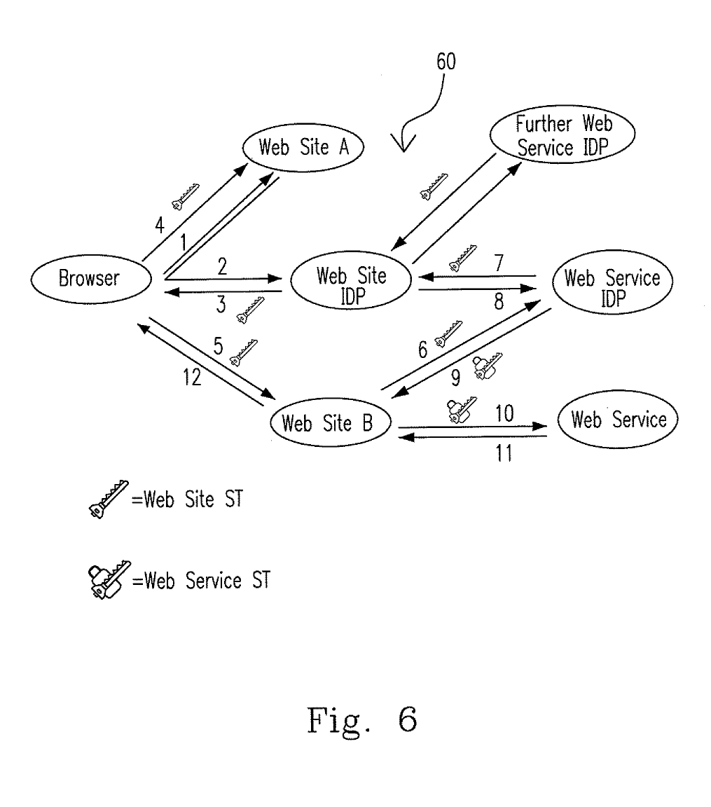

Referring to FIG. 6, which is a schematic diagram of the concept embodiment of the operation procedure of a single sign-on method and system for a web browser according to the present disclosure, a SSO system 60 for a web browser having two web sites web site A (i.e. the first web site), web site B (i.e. the second web site) therein are shown. The two web sites belong to the binding of the SAML HTTP POST/Redirect/Artifact, and under the government of the validation success or failure and the limits of authority itself of the same one web site IDP. There is a web service at the back end, and the web service proceeds the single sign-on of the web service by another web service IDP. The first web site validates an entrance data (including the account and the cipher) when the browser asks to access the first web site. User 10 can utilize the SSO function of the web site IDP to get the web site ST, and logins the Web Site A and the Web Site B. The web site B asks a certificate first from the commanding web service IDP according to the system of the SAML PAOS Binding when user 10 needs to access the web service of the back end by the second web site B. The certificate is one web service ST. The web service IDP asks the web site B that the web site ST obtained by the second web site from the web site IDP must be checked for the proof of identity validation of web service, and entreats the web site IDP to corroborate the web site ST provided by the second web site B. After the web site ST corroborated is legal, it may be confirmed that the user of the second web site B is really through a normal procedure to login the second web site B, so as to establish a communicating system for the web site IDP and the web service IDP. Then the web service ST is issued to user 10 of the second web site B. Eventually, the user is right able to access the application information in the web service by the web service ST through the second web site B, further to integrate the web site and the web service into unitary single sign-on domain.

By means of this pattern system, so user 10 login once to use oneself identity validation information for accessing any web site and web service within limits of authority. Both the web site and the web service know the identity of present end user 10 through the SSO system. The web service can assure end user 10 to login the web site in the SSO domain through normal procedure already.

There is no need to change the identity provider if it has corresponded to the SAML standard or other web sites based on the identity provider or the web service SSO. According to FIG. 6, there are steps of: demanding to access the web site A first, forcing to login if it doesn't login yet after the judging, then requesting the web site ST of the web site SSO form the web site IDP, and issuing the web site ST, next accessing the web site A, then demanding to access the web site B by the web site ST, requesting the web service ST first form the web service IDP of the web service by the web site ST due to the web site B requiring the web service to provide data, then validating whether the web site ST is legal or not from the web site IDP, and responding whether the web site ST is legal or not, issuing the web service ST after judging, accessing the web service by the web service ST, responding to the user by the web service, and finally displaying the page content at the web site B.

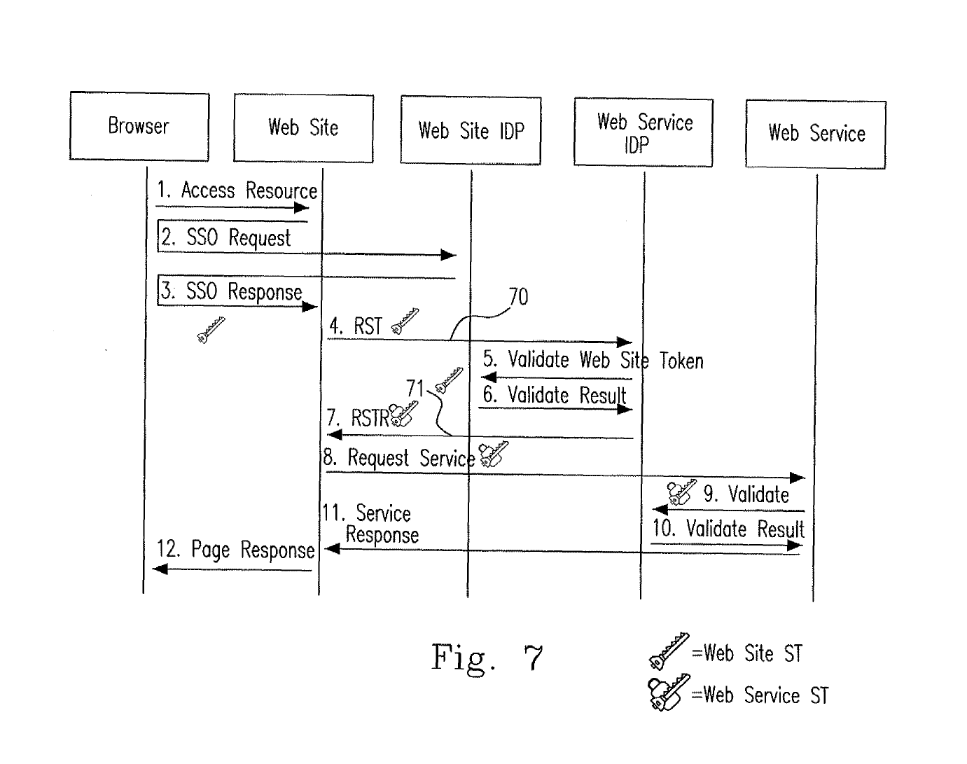

Referring to FIG. 7, there is shown the procedure of the steps included according to the system of the present disclosure. That is to say, when the user logins some web site and the page of the web site is necessary to call the content of some web service as the displaying data of the page, the procedure is as follows:

The user utilizes to surf the web browser for requesting to access a web site, if the web site checks the user who doesn't login yet, then it directs the user to the entering page of the web site and waits the user to enter his account and cipher or manipulate other identity check system, e.g. the Public Key Infrastructure (PKI) chip to check;

The web site issues a request of the SSO to the web site IDP if it succeeds to login;

The web site IDP check whether the SSO request is legal or not, if it's legal, then the SSO response of the web site ST attached is issued;

The web site (e.g. the web site B) accepts the accessing request of user 10, it's necessary to call the web service as the page content is provided, and the service needs one web service ST to be just able to pass the validation, meantime the web site checks itself without the security certificate of the service, thus a Request Security Token (RST) 70 is issued to the commanding web service IDP of the service by the web site token, for requesting the web service ST needed by the service;

The web service IDP validates whether the web site ST obtained is legal or not by the web site IDP;

The web site IDP responds to the web service IDP about the legality of its web site ST, as the legality of the token is checked, we can check whether the sign seal of the token is legal or not first, and furthermore the serial number and the user ID of the token are transmitted to the web site IDP, then checking whether the user is still during the legal entrance period, and the token is effective if the user is an user of the legal single sign-on;

The web service IDP makes a Request Security Token Response (RSTR) 71 to the web site, and the RSTR would have the web service ST attached if the web site token is judged to be legal—otherwise the judgment is continued if it's illegal;

The web site requests the service from the web service by the web service ST;

The web service checks whether the web service ST is legal or not by the web service IDP;

The web service IDP responds the legality of the web service ST;

The result transmitted from the web service is sent to the web site; and

The page is displayed on the browser by the web site.

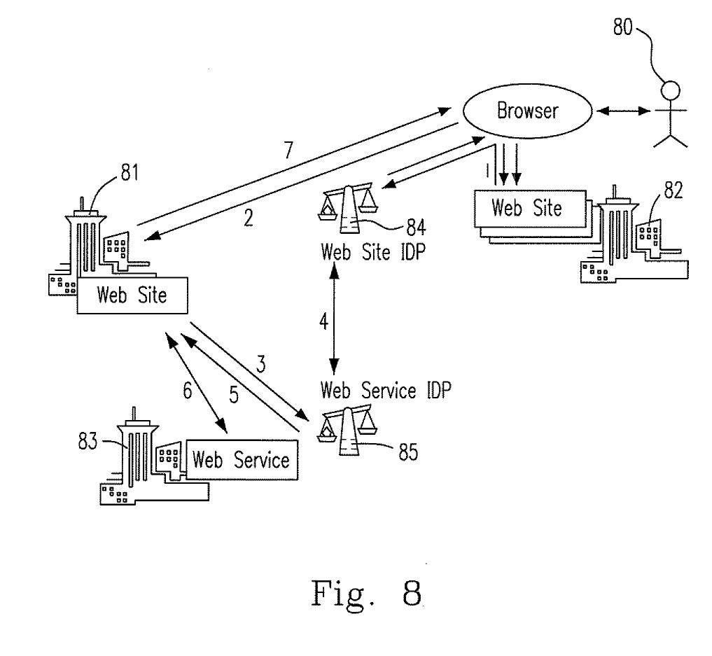

Referring to FIG. 8, which is a schematic diagram of an embodiment of a single sign-on method and system for a web browser according to the present disclosure. Some local hospital 81 cooperates with many clinics 82 and a system of several community medical treatment groups are formed by many clinics, and through a third party of an anamnesis exchange center 83 being a web service center to integrate the anamnesis data of each clinic 82 and local hospital 81, which is an application information. Local hospital 81 helps also each clinic in each community medical treatment to establish a web site possessing the basic clinic enquiry, appointment and associator system. The web sites of both each clinic 82 and local hospital 81 can do the single sign-on each other. The web site of the local hospital 81 provides the function which the medical treatment record of a recent year in the medical treatment system be inquired to patients. Clinics 82 of the community medical treatment groups in the system would transmit timely the anamnesis data to anamnesis exchange center 83. A patient Bob 80 of clinic commanded by the community medical treatment group can login by medical treatment clinic 82, and link to the web site of local hospital 81 for inquiring the medical treatment record, and the web site of local hospital 81 obtains the medical treatment record of each clinic 82 in the community medical treatment groups further by the web service of anamnesis exchange center 83. The medical treatment record is an application information.

Under the circumstance, the associator data of patient 80 is at his diagnosing clinic 82, therefore one must login the web site of one's clinic 82, and the web site ST is obtained at the same time when one logins from identity centre. Then one can utilize the SSO system for linking to the page of the medical treatment record enquiry of the web site of the local hospital with a view to inquire personal medical treatment. The page uses the web service of the anamnesis exchange center to inquire the medical treatment record of each clinic, hence it obtains the web service ST first by the web service IDP of exchange center, then the medical treatment information of each clinic is obtained from the web service. Because the web service can know the identity validation information of the user therein, it can strengthen the secure control of the confidential data further to the anamnesis et cetera. The procedure is as follows:

Bob logins by the web site of the clinic of the community medical treatment group, and meantime obtains the web site ST issued by a web site IDP 84;

One can login the web site of the local hospital to inquire the medical treatment record;

The web site of the local hospital requests the web service ST from a web service IDP 85;

Web service IDP 85 request web site IDP 84 to validate whether Bob is one of the entering web site by a legal way or not;

The web service ST is responded to the web site of the local hospital;

When the web site of the local hospital access the web service of the anamnesis exchange center by the web service ST, the web service can know that the accessing one is Bob from the local hospital, and judges whether the man has the limits of authority to access or not; and

The page data of the web site is transmitted to the user.

Through the web service center (i.e. the anamnesis exchange center), Bob of the local hospital is presumed to examine the medical treatment record of Bob by the foregoing procedure.

Consequently, we carry out the IDP by the disposal of two stages, which sorts the IDP into the web site IDP and the web service IDP. All the web sites would possess one web site IDP together, and the web site IDP can cooperate with many web service IDPs. The web site IDP is further in charge of the web service IDP governed and proceeds the work of validation except that it's responsible for the SSO work of the web site. The user would obtain the web site ST issued by the web site IDP as one logins the web site, and furthermore it accomplishes that user 10 can use the web site ST to request the web service ST from the web service IDP for accessing the web service needed.

In other words, the present disclosure is a single sign-on method for a web browser, which includes the following steps of validating an entrance data by a first web site (e.g. the web site of clinic 82), providing a web site security token to the web browser when the first web site validates the entrance data as correctness, accessing a second web site (e.g. the web site of local hospital 81) by the web site security token, generating a web service security token by the second web site, issuing the web service security token to the second web site when the web site security token is validated as correctness, and then providing the web service security token by the second web site, and accessing an application information by the second web site with the web service security token for transmission the application information to the first web site. Certainly, now the web site security token is issued from a web site identity provider. The web service security token is generated from a web service identity provider by a request of the second web site. The web site security token is validated at the web site identity provider by the web service identity provider. The web service security token is issued to the second web site when the web site identity provider responds a correct result to the web service identity provider. The application information is issued from a web service center. The web service security token is validated at the web service identity provider by a request of the web service. The present method further includes a step of validating the web site security token again when the web site identity provider responds an incorrect result to the web service identity provider.

Therefore, the present disclosure is a single sign-on method, which includes steps of receiving a web site security token, utilizing the web site security token to request a web service security token, issuing the web service security token when the web site security token is validated as correctness, and utilizing the web service security token to access an application information. Certainly, now the web site security token is validated at a web site identity provider by a web service identity provider. The web site security token is issued from the web site identity provider. The web service security token is issued from the web service identity provider and requested by a web site (e.g. the second web site B). The web service security token is issued to the web site when the web site identity provider responds a correct result to the web service identity provider. The present method is applied in a web browser.

Certainly, system 60 can further include a further web service identity provider validating the web site security token by the web site identity provider, i.e. the web site IDP can validate the legality of the web site ST for many web service IDPs (including the further web service IDP and the web service IDP). Similarly, system 60 can also include a further web service center (not shown in fig.) accessed with the web service security token issued by the web service identity provider, i.e. the web service IDP can issue the web service ST for many web services (including the further web service center and the web service center) to proceed the SSO, and the different web service can belong respectively to different web service IDP. One can need no to perform the entering procedure again after the user logins a web site. Then one can use oneself identity to access each web site and web service. In sum, the user can use the web site ST to be a purpose of identity validation, the legality of the web site ST of the user is validated by the web site IDP from the web service IDP, and it is used to regards as the basis whether the web service ST is issued or not.

Provided that it is viewed from another acceptable pattern, the present disclosure is a single sign-on system 60, including a first identity provider (e.g. the web site identity provider) providing a web site security token, a second identity provider (e.g. the web service identity provider) providing a web service security token, when the web site security token is validated as correctness for a requesting instruction, then deciding whether the web service security token is issued or not, and a web service center accessed by the web service security token, then providing an application information. Certainly, now the system can further include a web site (e.g. the first web site or the web site of clinic 82) validating an entrance data, and a second web site (e.g. the web site of local hospital 81) accessed by the web site security token and issuing the requesting instruction. The first identity provider is a web site identity provider, the second identity provider is a web service identity provider, and the application information is provided to the web site. The present system further includes a further web service identity provider connected to the web site identity provider, validating the web site security token by the web site identity provider and providing a further web service security token being different from the web service security token. The present system further includes a further web service center accessed with the web service security token provided by the web service identity provider, wherein the web service center and the further web service center have respective data being different from each other. The web service center is an anamnesis exchange center.

So the application programs of the front and the back end of the present disclosure can trust different secure ST, then the elasticity of the application program deployed is increased, and meantime it's compatible to the prior SSO truss. Except this one function, the present disclosure makes the user be able to login once for accessing many front end application programs (web site), and meantime one accesses the back end application program (web service) by oneself identity at different web site. In addition, the present disclosure addresses the method that can contain plural identity providers by the stage truss, moreover, it gets across the service of the two various constitution interfaces of the web site and the web service. The token of the present disclosure doesn't record other IDP data, and each web site or web service also only accepts the token provided by its commanding IDP. The web service also only confides the web site IDP without forming the trust chain. And the web service IDP of the present disclosure would confirm the entering condition of the user at the web site IDP after obtaining the token.

We conclude the present disclosure can request the legality of the web site ST provided by the web site B at the web site IDP by the web service IDP, so it can be confirmed that the user of the web site B is really through a normal procedure to login the web site B, and really able to accomplish the purpose of using simultaneously many web service IDPs in one SSO domain. While the disclosure has been described in terms of what are presently considered to be the most practical and exemplary embodiments, it is to be understood that the disclosure need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What we claim is:

1. A single sign-on method for a web browser, comprising steps of:
validating an entrance by a first web site;
providing a web site security token to the web browser when the entrance is validated being correct;
accessing a second web site by the web site security token;
generating a web service security token by the second web site;
issuing the web service security token to the second web site when the web site security token is validated being correct; and
accessing an application information from a web service by the second web site with the web service security token for transmission thereto the first web site.

2. A method according to claim 1, wherein the web site security token is issued from a web site identity provider.

3. A method according to claim 2, wherein the web service security token is generated from a web service identity provider.

4. A method according to claim 3, wherein the web site security token is validated at the web site identity provider by the web service identity provider.

5. A method according to claim 4, wherein the web service security token is issued to the second web site when the web site identity provider responds a correct result to the web service identity provider.

6. A method according to claim 5, wherein the application information is issued from a web service center.

7. A method according to claim 6, wherein the web service security token is validated at the web service identity provider by a request of the web service.

8. A method according to claim 4, further comprising a step of validating the web site security token again when the web site identity provider responds an incorrect result to the web service identity provider.

9. A single sign-on method, comprising steps of:
receiving a web site security token;
utilizing the web site security token to request a web service security token;
issuing the web service security token when the web site security token is validated as correct; and
utilizing the web service security token to access an application information.

10. A method according to claim 9, wherein the web site security token is validated at a web site identity provider by a web service identity provider.

11. A method according to claim 10, wherein the web site security token is issued from the web site identity provider.

12. A method according to claim 11, wherein the web service security token is issued from the web service identity provider and requested by a web site.

13. A method according to claim 11, wherein the web service security token is issued to the web site when the web site identity provider responds a correct result to the web service identity provider.

14. A method according to claim 9 being applied in a web browser.

15. A method according to claim 9, wherein the web site security token is to be validated.

16. A single sign-on system for a web browser, comprising:
a first identity provider providing a web site security token to the web browser;
a second identity provider validating the web site security token at the first identity provider and providing a web service security token; and
a web service center accessed by the web service security token and providing an application information.

17. A system according to claim 16 further comprising a web site, wherein the first identity provider is a web site identity provider, the second identity provider is a web service identity provider, the web site accessed by the web site security token and the application information is provided to the web site.

18. A system according to claim 17 further comprising a further web service identity provider connected to the web site identity provider, validating the web site security token by the web site identity provider and providing a further web service security token being different from the web service security token.

19. A system according to claim 17 further comprising a further web service center accessed with the web service security token provided by the web service identity provider, wherein the web service center and the further web service center have respective data being different from each other.

20. A system according to claim 16, wherein the web service center is an anamnesis exchange center.
